(19) United States
(12) Patent Application Publication
(10) Pub. No.: US 2007/0153709 A1
(43) Pub. Date: Jul. 5, 2007

(54) Method of notifying the presence of a terminal in a communications system and a system therefor

(75) Inventor: Jang-Geon Choi, Suwon-si (KR)

Correspondence Address: DILWORTH & BARRESE, LLP, 333 EARLE OVINGTON BLVD., SUITE 702, UNIONDALE, NY, 11553, US

(73) Assignee: SAMSUNG ELECTRONICS CO., LTD., Suwon-si (KR)

(21) Appl. No.: 11/585,500

(22) Filed: Oct. 24, 2006

(30) Foreign Application Priority Data
Jan. 3, 2006 (KR) 2006-597

(51) Int. Cl. H04L 12/28; H04L 12/56

(52) U.S. Cl. 370/254; 370/395.2

(57) ABSTRACT

Disclosed is a method notifying the presence information of terminals in an electronic communications system including a plurality of terminals, at least an IP Multimedia Subsystem (IMS) ( ) server, and a presence server for managing the presence information of the terminals. The method causes one of the terminals to transmit a notification message of its presence information containing communication state information to the IMS, causes the IMS server to the communication state information of the other terminals retrieved from the presence server to the one terminal in response to the notification message, the other terminals being registered by the user of the one terminal, and causes the one terminal to display the communication state information of the other terminals.

### PRIORITY

This application claims priority under 35 U.S.C. §119 to an application entitled “Method of Notifying The Presence of a Mobile Terminal And a System Therefor” filed in the Korean Intellectual Property Office on Jan. 3, 2006 and assigned Serial No. 2006-0000597, the contents of which are incorporated herein by reference.

### BACKGROUND OF THE INVENTION

1. Field of the Invention

The present invention relates to a method and system of notifying the users of mobile terminals constituting a registered group of the presence of the terminals in an electronic communications system.

2. Description of the Related Art

Generally, the Internet Protocol (IP) Multimedia Subsystem (IMS) is a system for providing packet communication services based on IP by using the Session Initiation Protocol (SIP) that is a text-based application control protocol. The SIP is of a client/server structure for governing the clients to call the server, and enabling a group of participants to arrange, revise, and end a session. The session can be a remote conference through Internet, telephonic conference, interview, notification of an event. The SIP is a signaling protocol for arranging, revising, and ending an Internet-based multimedia service session, and enabling a group of persons to exchange the information for controlling their message exchange session. In the Public Switched Telephone Network (PSTN), the telephone communication is attained by sequentially dialing the phone number of the distant party, receiving a responding signal ringing, and the distant party under the governing of a suitable signaling protocol picking up of the handset. Likewise, the SIP is a signaling protocol provided by the Multiparty Multimedia Session Control (MMUSIC) of the Internet Engineering Task Force (IETF) to be used for Internet telephony service, remote conference, voice mail, etc.

The terminals connected with the IMS provide Active Phone Book (APB) services for enabling the users of the terminals to register their presence information in a presence server and to check the presence information of each other by retrieving the presence information from the presence server. Hereinafter, the other users registered by one user are referred to as “registered users”.

Conventionally, the APB services enable the user's terminal to receive and display only the active/non-active information of the registered users, so that the user can only note their active or non-active state. Hence, if a user makes a call to one of the activated registered users, who has already made a connection with another user, his/her calling operation becomes useless. Namely, the conventional APB services cannot enable the user to check whether the activated registered users are making a connection with another.

### SUMMARY OF THE INVENTION

It is an object of the present invention to provide a method of providing a user's terminal with APB services enabling it to check the communication state of the registered users' terminals connected with the IMS in an electronic communications system, and a system therefor.

According to an aspect of the present invention, an electronic communications system including a plurality of terminals, at least an IMS server, and a presence server for managing the presence information of the terminals, is provided with a method of notifying the presence information of terminals, which includes causing one of the terminals to transmit a notification message of its presence information containing communication state information to the IMS server, causing the IMS server to transmit the communication state information of the other terminals retrieved from the presence server to the one terminal in response to the notification message, the other terminals being registered by the user of the one terminal, and causing the one terminal to display the communication state information of the other terminals.

According to another aspect of the present invention, a system for notifying the presence information of terminals includes a plurality of terminals for generating their respective presence information containing their respective communication state information, a presence server for managing the presence information containing the communication state information, and an IMS server for receiving the communication state information of the terminals from the presence server, wherein if one of the terminals transmits a notification message of its presence information containing the communication state information to the IMS server, the IMS server retrieves the presence information containing the communication state information of the other terminals registered by the user of the one terminal from the presence server, and transmits it to the one terminal for displaying it.

### BRIEF DESCRIPTION OF THE DRAWINGS

The above and other objects, features and advantages of the present invention will become more apparent from the following detailed description when taken in conjunction with the accompanying drawing in which:

FIG. 1 is a schematic diagram for illustrating an electronic communications system providing the Active Phone Book (APB) services according to the present invention;

FIG. 2 is a flowchart for illustrating the exchange of signals between a terminal and an IP Multimedia Subsystem (IMS) server to provide the Active Phone Book (APB) services according to the present invention;

FIG. 3 is a flow chart for illustrating the process of a terminal providing the Active Phone Book (APB) services according to the present invention;

FIG. 4 is a flow chart for illustrating the process of displaying the communication state of the other terminals registered by the user of one terminal on the Active Phone Book (APB) screen according to the present invention;

FIGS. 5A and 5B illustrate the communication state of the users of the other registered terminals displayed in the Active Phone Book (APB) screen according to the present invention; and

FIG. 6 is an example of the format of the PUBLISH method provided by the invention for causing the terminal to transmit the presence information containing the communication state information to the IP Multimedia Subsystem (IMS)server in the process of FIG. 2 according of the present invention.

### DETAILED DESCRIPTION OF THE PREFERRED EMBODIMENTS

Preferred embodiments of the present invention will be described herein below with reference to the accompanying drawings. In the drawings, the same or similar elements are denoted by the same reference numerals even though they are depicted in different drawings. In the following description, well-known functions or constructions are not described in detail since they would obscure the invention in unnecessary detail.

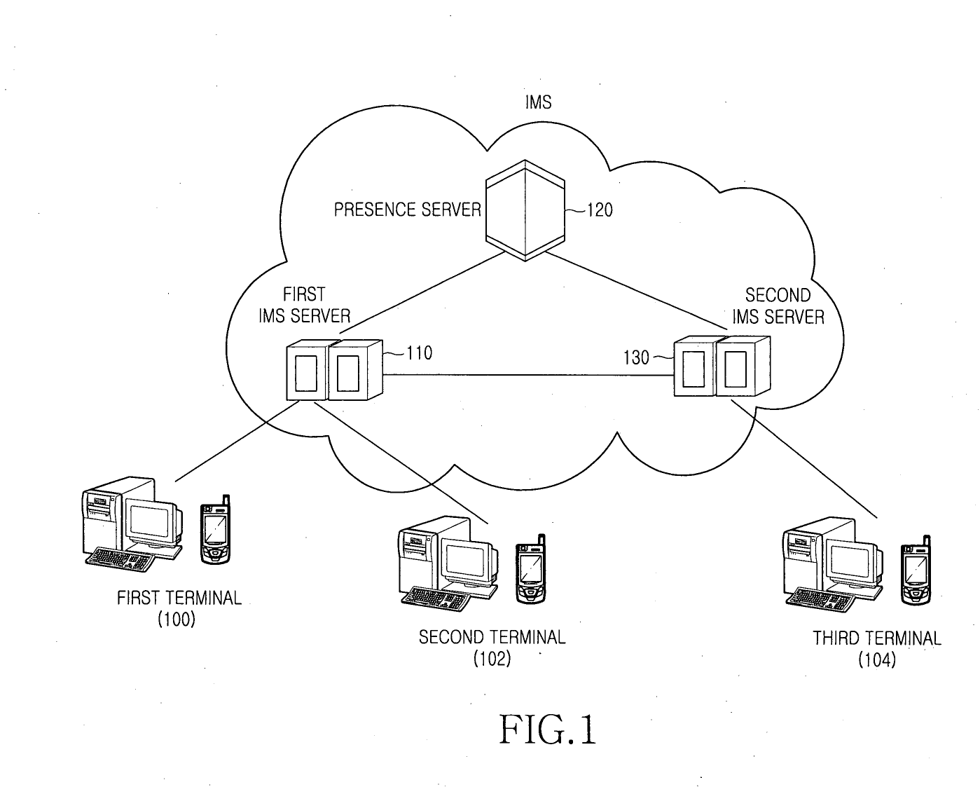

The present invention enables a mobile terminal to provide its presence information containing the communication state information with Active Phone Book (APB) services in an electronic communications system. Referring to FIG. 1, the electronic communications system includes a plurality of terminals 100 102, 104, IP Multimedia Subsystem (IMS) servers 110, 130 for treating a session of the terminals, and a presence server 120 for maintaining/managing the presence information of the terminals. According to the present invention, the terminals and servers have the following functions.

The terminals 100 102, 104, which can be one of a wired, wireless, and combined type, are required to transmit and receive the presence information containing the communication state information through a Session Initiate Protocol (SIP). Each of the terminals is also required to compare the newly received presence information containing the communication state information of the other terminals registered by its user with the previous one to display the changed communication state in the APB services, so that the user of the terminal can check the communication state of the other registered terminals.

The IMS servers 110 and 130 control the connection and disconnection of a call between a calling party and a called party of the terminals 100, 102, and 104. The IMS server also transmits a PUBLISH message of the presence information of the terminals received from the activation of the APB services to the presence server 120 for storing it. It also retrieves the presence information of the other terminals registered by the user of the terminal having transmitted the publish message from the presence server 120, transmitting it to the terminal of the user having registered the other terminals.

The presence server 120 manages the presence information of the subscribers' terminals to provide it to the IMS servers 110 and 130 upon request. According to the present invention, the presence information contains the active/non-active information of the APB services of the terminals together with their communication state information.

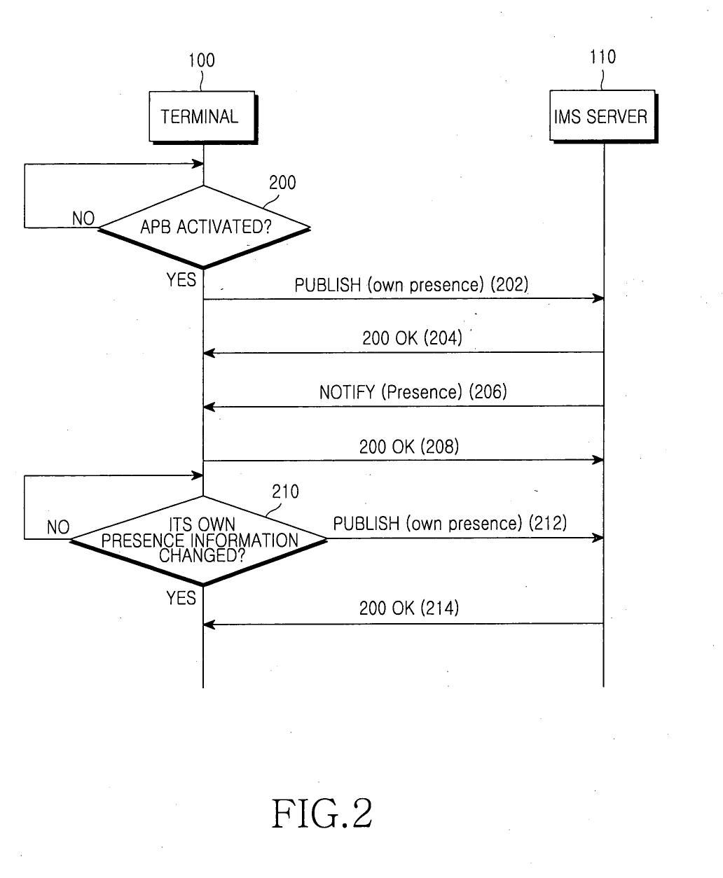

Referring to FIGS. 1 and 2, there is illustrated the process of the IMS server 110 cooperating with the presence server 120 to transmit send the presence information of the terminals registered by a particular terminal 100 upon the request of the particular terminal activating the APB services. Particularly, FIG. 2 illustrates the signals exchanged between the terminal 100 and the first IMS server 100 for enabling the terminal 100 to perform the APB services.

Foremost, in step 200 the terminal 100 activates the APB services to transmitting step 202 a PUBLISH message containing its presence information to the IMS server 110. In this case, the presence information contains the active information notifying the activation of the APB services and the communication state information of the terminal.

Thereafter the IMS server 110 transmits in step 204 200 OK message to the terminal 100 in response to the PUBLISH message, and the presence information of the terminal 100 to the presence server 120 for storing it. In addition, the IMS server 110 retrieves the presence information of the other terminals registered by the user of the terminal 100 from the presence server 120 to transmit it as a NOTIFY message to the terminal 100 in step 206. Notably, the presence information contains the active information notifying the activation of the APB services and the communication state information of the other registered terminal. In response to the NOTIFY message the terminal 100 transmit 200 OK message to the IMS server 110.

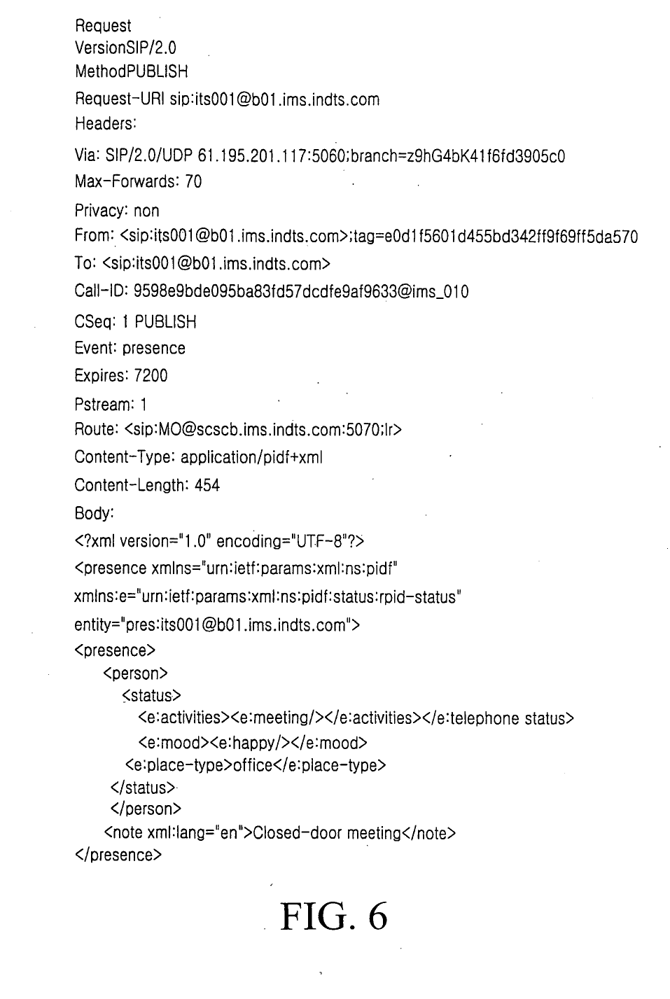

Then, in step 210, the terminal 100 checks whether its presence information is changed. In this case, the change of the presence information means the change of the communication state information of the terminal, or the APB services changed to one of an active and non-active state. In step 212, the presence information being changed, the terminal transmits another PUBLISH message containing the changed presence information to the IMS server 110, which in turn transmits 200 OK message as the response to the terminal 100, and the changed presence information to the presence server 120 to update the previous one of the terminal 100. FIG. 6 illustrates a desirable PUBLISH method for the terminal 100 to transmit the presence information containing its communication state information to the IMS server 110. The terminal 100 inserts flags such as <e:activities>, <e:meeting/>, </e:activities>, </e:telephone status>, <e:mood>, <e:happy/>, </e:mood>, <e:place-type>office, and </e:place-type> in the “<status>” of the “<presence>”. Understandably , the other registered terminals also transmit a message containing the flag defining the communication status “</e:telephone status>” to the IMS server 110 in order to notify their communication state upon starting the APB services.

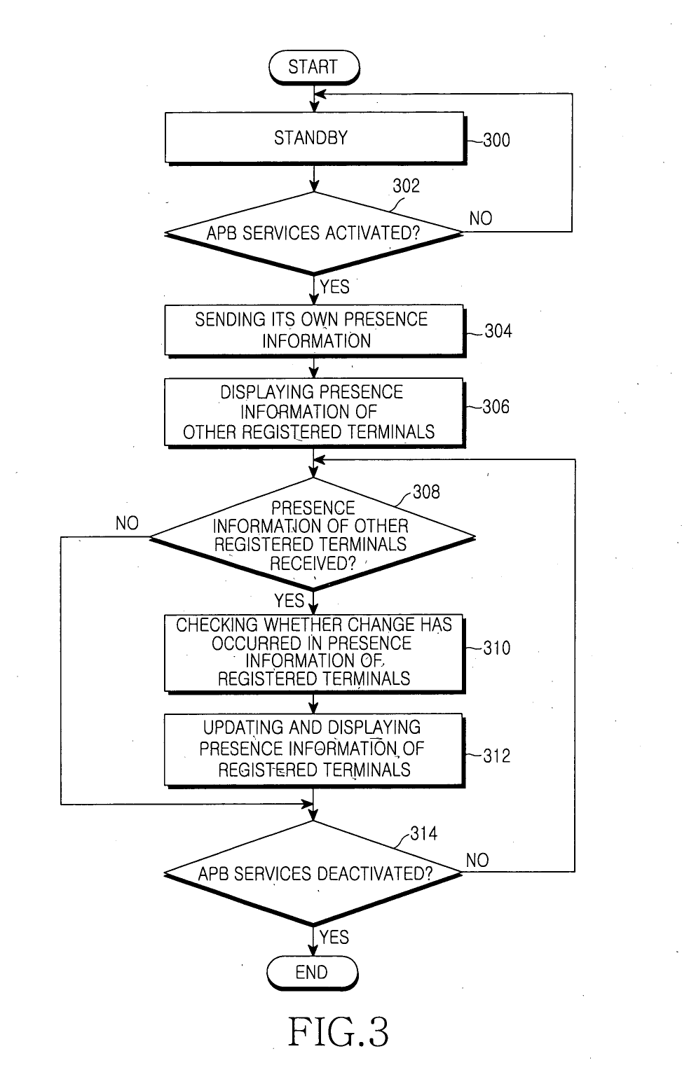

Meanwhile, in step 206, after transmitting in step 206 the presence information of the other terminals registered by the user of the terminal 100 activating the APB services, the IMS server 110 periodically retrieves the updated presence information of the other registered terminals from the presence server 120 to transmit it to the terminal 100 at a predetermined period. In this case, in order to transmit the updated presence information of the other registered terminals to the terminal 100, the IMS server 110 can transmit the presence information of the whole registered terminals or that of the registered terminals having changed the presence information. Accordingly receiving the updated presence information of the other registered terminals, the terminal 100 displays it on the APB screen. Hereinafter, the process of the IMS server 110 transmitting the presence information of the whole registered terminals to the terminal 100 activating the APB services is more specifically described in connection with FIG. 3.

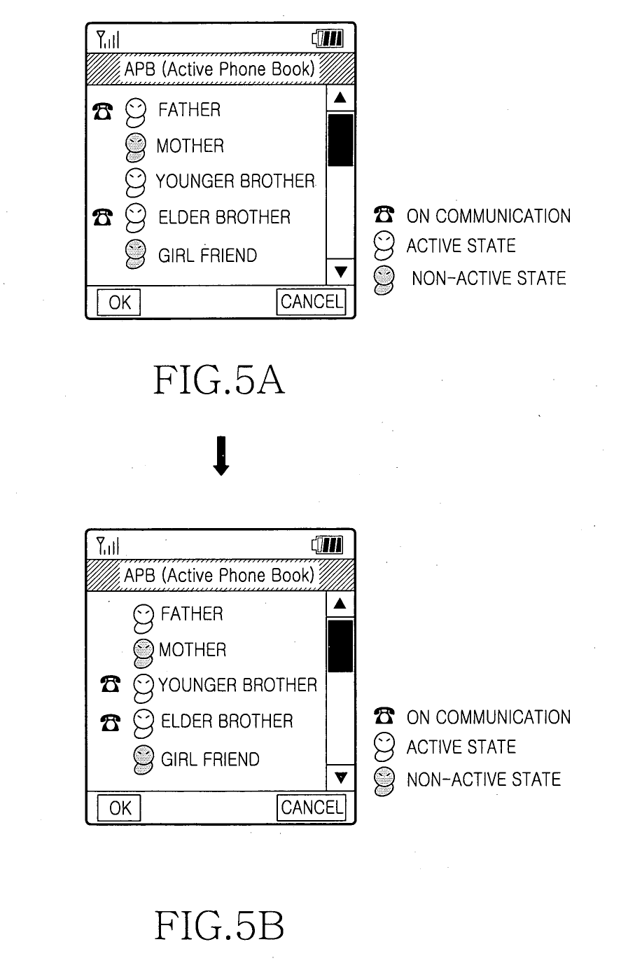

Referring to FIG. 3, in step 300 the terminal 100 on standby in step 300 is activated in step 302 to proceed to step 304 to transmit its own presence information to the IMS server 110. Then in step 306, the terminal 100 displays on the screen the presence information of each of the other registered terminals received from the IMS server 130. The displaying screen is as illustrates in FIGS. 5A and 5B. Referring to FIG. 5A, there are displayed the icon representing the name and the active or non-active state of the APB services of each of the users of the other registered terminals together with the icon representing the communication state. Accordingly, the subscriber can check by the communication state representing icon whether each of the other registered terminals is in communication with another terminal.

Thereafter, the terminal 100 proceeds to step 308 to receive the presence information coming periodically or updated from the IMS server 110. If receiving the presence information, it proceeds to step 310, or otherwise to step 314 to check whether the APB services are deactivated. If the APB services have been deactivated, the terminal 100 is terminated, or otherwise returns to step 308 to stand by for reception of the presence information of the other registered terminals.

Meanwhile, in step 308, receiving the presence information of the other registered terminals it proceeds to step 310 to check whether there has occurred a change compared to the previous presence information. If there has been a change in the presence information of any of the other registered terminals, the terminal 100 updates the presence information of the registered terminal displayed on the screen. Then it proceeds to step 314 to determine whether the APB services are deactivated. If the APB services have been deactivated, the terminal 100 is terminated, or otherwise returns to step 308.

Referring to FIGS. 5A and 5B, the terminal 100 displays the presence information of the other registered terminals on the screen. The users of the other registered terminals include “Father”, “Mother”, “Younger Brother”, “Elder Brother”, and “Girl Friend” in the present invention. Among these, “Father”, “Younger Brother”, and “Elder Brother” are activating the APB services with “Father” and “Elder Brother” presently on communication in FIG. 5A. From this state, if the terminal 100 receives the newly updated presence information of the other registered terminals from the IMS server 110, it revises the presence information previously displayed on the screen as shown in FIG. A into that as shown in FIG. 5B where “Father” is not on communication, and “Younger Brother” and “Elder Brother” on communication.

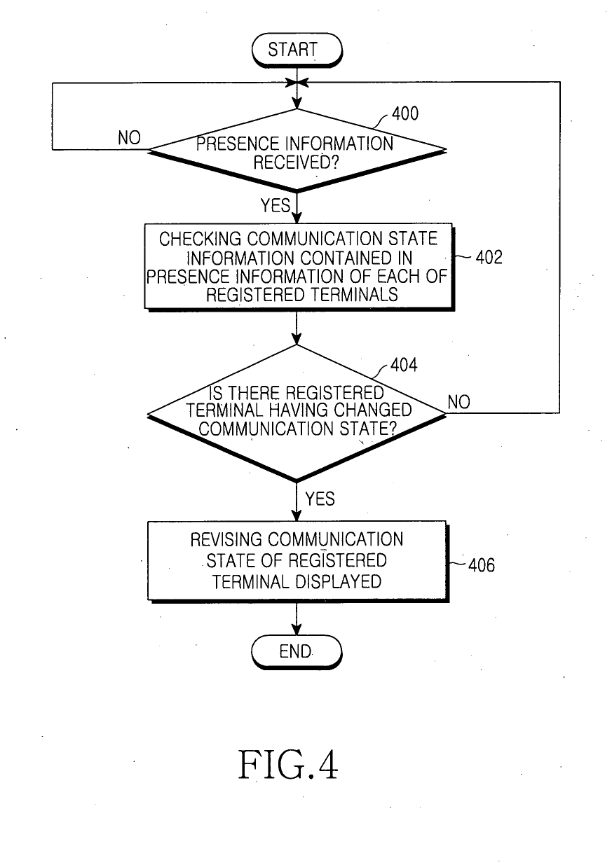

FIG. 4 illustrates the process of revising the presence information of the other registered terminals displayed on the screen of the terminal 100 when the communication state information is changed in the process as illustrates in FIG. 3. First, it is assumed that the terminal 100 has activated the APB services along with displaying the presence information on the screen.

Then receiving again in step 400 the presence information of the other registered terminals, the terminal 100 proceeds to step 402 to check the communication state of the registered terminals. Consequently, if there is discovered in step 404 a registered terminal having changed the communication state, the terminal 100 proceeds to step 406 to revise the communication state of the terminal displayed on the screen. Or otherwise, it returns to step 400 to stand by for the presence information. Although the process as shown in FIG. 4 is to display only the changed communication state of the registered terminal, there can be no limitation in displaying all the changed information containing the presence information of the registered terminal.

As described above, the present invention provides a user's terminal with APB services enabling it to check the communication state of the registered users' terminals connected with the IMS in an electronic communications system, so that the user does not have to make an unnecessary call to one of the activated registered users having already made a connection with another.

While the invention has been shown and described with reference to a certain preferred embodiment thereof, it will be understood by those skilled in the art that various changes in form and details may be made therein without departing from the spirit and scope of the invention as described in the appended claims.

What is claimed is:

1. In an electronic communications system comprising a plurality of terminals, at least an IP Multimedia Subsystem (IMS) server, and a presence server for managing the presence information of said terminals, a method of notifying the presence information of said terminals, comprising the steps of:
causing one of said terminals to transmit a notification message of its presence information containing communication state information to the IMS server;
causing said IMS server to transmit the communication state information of the other terminals retrieved from said presence server to said one terminal in response to said notification message, the other terminals being registered by the user of said one terminal; and
causing said one terminal to display the communication state information of said other terminals.

2. A method as defined in claim 1, further comprising
causing said one terminal to transmit another notification message of the presence information containing its changed communication state information to said IMS server; and
causing said IMS server to transmit the changed communication state information of said one terminal to said presence server to update the communication state information of said one terminal.

3. A method as defined in claim 1, wherein transmitting the presence information containing the communication state information of said other registered terminals is performed at a predetermined period or whenever the presence information containing the communication state information is updated.

4. A method as defined in claim 3 further comprising, transmitting only the updated communication state information whenever the presence information containing the communication state information is updated.

5. A method as defined in claim 1, wherein said one terminal compares the communication state information of said other terminals presently received with the previous one to display the communication state information changed.

6. A system for notifying the presence information of terminals comprising:
a plurality of terminals for generating their respective presence information containing their respective communication state information;
a presence server for managing the presence information containing the communication state information; and
an IP Multimedia Subsystem (IMS) server for receiving the communication state information of said terminals from said presence server, wherein if one of said terminals transmitting a notification message of its presence information containing the communication state information to said IMS server, said IMS server retrieves the presence information containing the communication state information of the other terminals registered by the user of said one terminal from said presence server, and transmitting it to said one terminal to display it.

7. A system as defined in claim 6, wherein said one transmits another notification message of the presence information containing its changed communication state information to said IMS server.

8. A system as defined in claim 7, wherein said IMS server transmits the changed communication state information of said one terminal to said presence server to update the communication state information of said one terminal.

9. A method as defined in claim 6, wherein said IMS server transmits the presence information containing the communication state information of said other registered terminals at one of a predetermined period and whenever the presence information containing the communication state information is updated.

10. A method as defined in claim 9, wherein said IMS server transmits only the updated communication state information whenever the presence information containing the communication state information is updated.

11. A method as defined in claim 6, wherein said one terminal compares the communication state information of said other terminals presently received with the previous one to display the communication state information changed.
